(19) United States
(12) Patent Application Publication
(10) Pub. No.: US 2009/0294430 A1
(43) Pub. Date: Dec. 3, 2009

(54) Heating apparatus for snow and ice removal

(76) Inventor: Alfonso Andrade, Montreal (CA)

Correspondence Address: PHILIP A. SWAIN, PhD, 50 KIRKWOOD AVENUE, BEACONSFIELD, QC, H9W 5L4, CA

(21) Appl. No.: 12/155,344

(22) Filed: Jun. 3, 2008

(51) Int. Cl. H05B 1/00

(52) U.S. Cl. 219/212

(57) ABSTRACT

Disclosed is a heating apparatus and apparatus for heating a cold surface of a vehicle or near the vehicle. The apparatus and apparatus comprise a heat source which is associated with the vehicle's surface for providing thermal energy transfer from the heat source to the cold surface so as to heat the cold surface.

### FIELD OF THE INVENTION

The present invention concerns a heating apparatus, and more particularly a heating apparatus for removing snow and ice from a surface.

### BACKGROUND OF THE INVENTION

In most northern climates, the removal of snow and ice that has accumulated on certain surfaces is particularly troublesome during the winter months. This is especially problematic for automobile owners, who are often faced with the task of manually removing the snow and ice accumulation from automobile surfaces prior to use. Manually removing the snow and ice can damage paint surfaces or wheel trims. This problem is particularly acute for automobile owners who may not have access to garage facilities, and who are often faced with the task of removing the snow and ice before the automobile can be used for commuting to and from the workplace. In addition, for less able-bodied person, the physical exertion required to manually remove the snow and/or ice can be potentially hazardous to the health, especially for persons with heart conditions.

In addition to automobile surfaces, snow and ice removal from pathways and steps near the automobile is also a problem. As above, the only currently available solution to this problem is to manually remove the snow and ice from the surfaces. This can be particularly problematic if there is significant snow and ice accumulation on the pathway near the wheels or underneath the chassis, where the removal can be awkward and often requires that the user bend his or her back. Generally speaking if the automobile owner is infirm or less able-bodied, this can result in injury.

Other than sheltering the automobile from the elements, there exists little in the way of relief for the aforesaid problems. Canadian patent application number CA 2,165,913 discloses a heating apparatus in which warm air is forced under a tarpaulin that is draped over a vehicle. The warm air is produced by a way of a propane tank with a burner. One significant drawback associated with this design is the potential for fire. Furthermore, the usefulness of the design is limited by the amount of propane available for ignition and as such the propane must be replenished to maintain effectiveness of the design. Moreover, the tarpaulin is limited to full coverage of the vehicle and does not appear to be adaptable to specific surfaces of the vehicle.

Other heating apparatus designs are generally limited for use with specific exterior automobile features including wing mirrors. Currently available engine block warmers are designed to merely heat the engine block prior to ignition so as to ensure rapid ignition on cold mornings. The currently available designs, however, do not address the issue of snow and ice removal from the automobile's surfaces.

Remote starters are typically used to remotely and automatically start the automobile. Generally speaking, remote starters allow the engine and interior of the automobile to be warmed before use. One significant drawback is that the automobile is left running for an extended period before use, which uses fuel and can pollute the atmosphere. Moreover, if the automobile is left running unattended, there is an increased likelihood of theft of the automobile.

In view of the aforesaid problems, there is clearly a need for a snow and ice removal apparatus that is safe, energy efficient and easy to operate.

### SUMMARY OF THE INVENTION

I have designed a novel snow and ice removal apparatus, which significantly reduces or essentially eliminates the aforesaid problems. The apparatus includes a heating source, which is located in contact with a surface before snow and ice accumulation occurs and provides heat transfer to the surface so that the snow and ice does not accumulate thereupon. The heating source is not limited to contact with the surface, and can also be built into the surface.

Accordingly, in one embodiment of the present invention, there is provided a heating apparatus for heating a cold surface of a vehicle or near the vehicle, the apparatus comprising: a heat source, the heat source being associated with the surface for providing thermal energy transfer from the heat source to the cold surface so as to heat the cold surface.

Typically, the heat source is located adjacent the surface. Alternatively, the heat source is integral with the surface. The heat source is remotely activated. The heat source is powered by a battery or the vehicle's climate control apparatus. The heat source is selected from the group consisting of: a heating mat, warm air blower, heating stripes, heating lamps, microwaves, lasers, and ultrasound. The heat source is a conduit having disposed therein an amount of a heat conductive material which, when activated, provides heat transfer to the surface. In one example, the surface is the exterior skin of the vehicle. In another example, the surface is the engine or engine components. In another example, the surface is the underside of the vehicle. In another example, the surface is a driveway or road on which the vehicle is located. The heat source is thermostatically controlled. The remote activation is operable by way of Bluetooth™, cellular telephones, satellite, or computer software. The heat source transfers thermal energy to the surface sufficient to melt snow and ice accumulated thereon or to reduce the accumulation of snow and ice thereon.

According to another aspect of the present invention, there is provided a heating apparatus for heating a cold surface of a vehicle, the apparatus comprising: a heating mat for location adjacent the surface, the heating mat being sized and shaped to cover at least a portion of the surface for providing thermal energy transfer from the heating to the cold surface so as to heat the cold surface.

Typically, the heating mat includes a heat source, the heat source being remotely activatable. The heat source is selected from the group consisting of: warm air blower, heating stripes, heating lamps, microwaves, lasers, and ultrasound. In one example, the heat source is a conduit having disposed therein an amount of a heat conductive material which when activated provides heat transfer to the surface. In one example, the surface is the exterior skin of the vehicle. In another example, the surface is the engine or engine components.

The heat source transfers thermal energy to the surface sufficient to melt snow and ice accumulated thereon or to reduce the accumulation of snow and ice thereon.

### BRIEF DESCRIPTION OF THE FIGURES

FIG. 1 is a perspective view of an embodiment of a heating apparatus located on or over an automobile exterior;

FIG. 1A is a perspective view of an alternative embodiment of a heating apparatus located over an automobile engine;

FIG. 2 is a view of a heating mat with a heat source.

### DETAILED DESCRIPTION OF THE INVENTION

Definitions

Unless otherwise specified, the following definitions apply:

The singular forms “a”, “an” and “the” include corresponding plural references, unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus the phrase “consisting of” indicates that the listed elements are required or mandatory and that no other elements may be present.

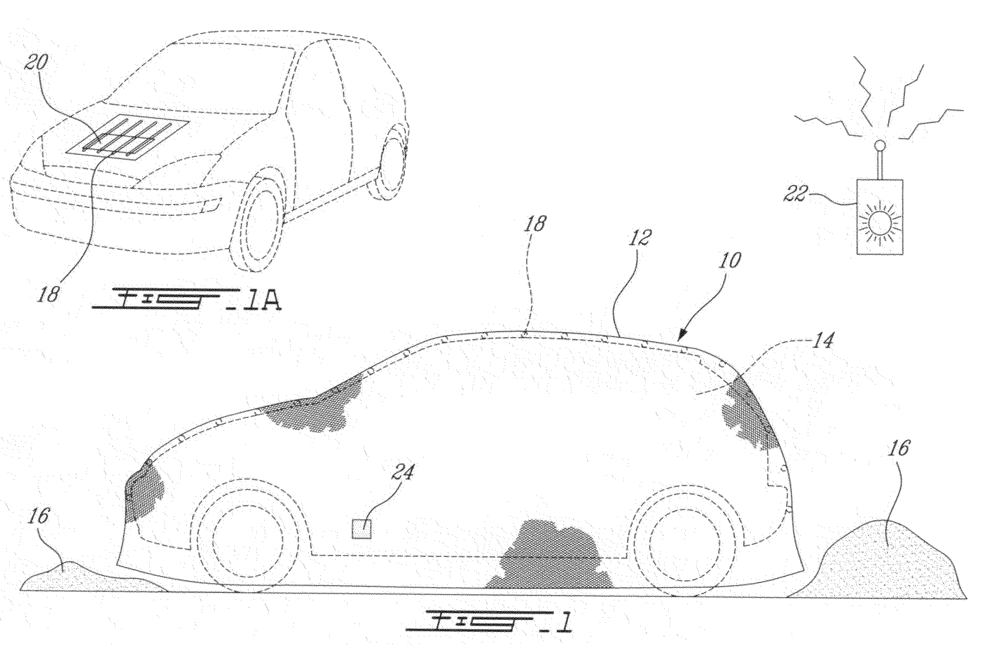

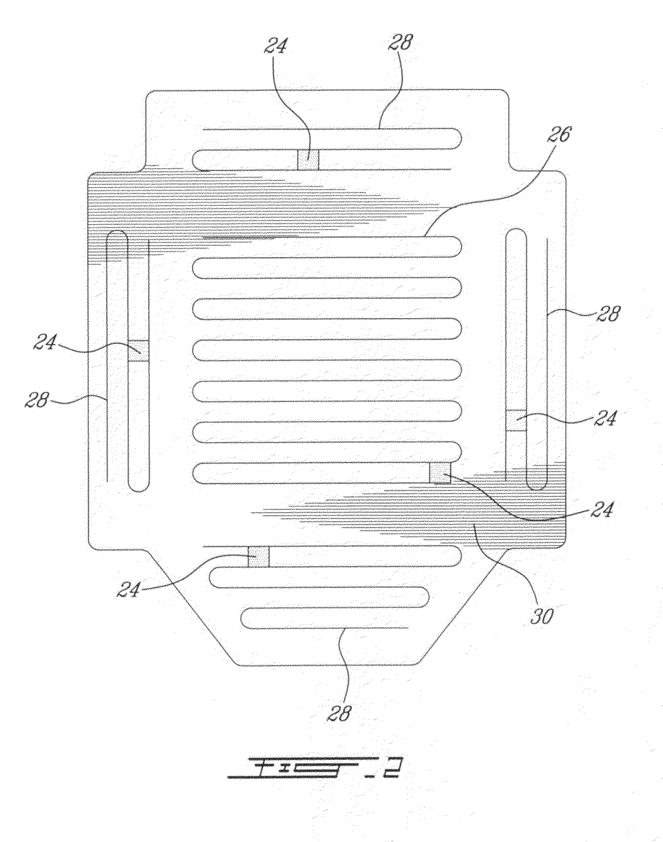

Referring now to FIG. 1, an embodiment of a heating apparatus is shown generally at 10. In the example illustrated, the heating apparatus 10 is located adjacent an cold exterior surface 12 of a vehicle 14, such as the exterior skin, panels, windshield, lights, wheels, locks, the underside of the vehicle chassis, exhaust pipes, fuel lines and such. It is to be understood that although an automobile is illustrated, the heating apparatus 10 may also be used to heat surfaces of trucks, trailers, boats, aircraft, spacecraft and such.

Broadly speaking, the heating apparatus 10 is used to heat the cold surface 12 of the vehicle 10. The cold surface 12 is generally one that has an accumulation of snow and/or ice 16 thereupon, or is a surface onto which snow and/or ice is expected to accumulate, such as before a snow storm. The apparatus 10 comprises a heat source 18, which is associated with the surface 12. The heat source 18 provides heat to the surface 12 by way of thermal energy transfer from the heat source 18. The thermal energy transfer heats the surface 12 to a temperature which is sufficient to melt the accumulated snow and/or ice, or is sufficient to significantly reduce or essentially eliminate the possibility of snow and/or ice accumulation thereon. Generally speaking, the cold surface 12 is at a temperature of 5° C. to −40° C. or lower.

The heat source 18 can be located adjacent the surface 12, or it may be integral with the material which defines the surface 16. In one example, the heat source 18 can be integrated into metal or non-metal or composite materials such as, but not limited to, fiberglass, polycarbonate, or any other power conductive or non-power conductive materials known to those skilled in the art. The materials referred hereto may also include materials derived from nanotechnologies.

As best illustrated in FIG. 1A, the heat source 18 can be located adjacent to the engine 20 or engine components of the vehicle such that they are heated prior to use. This can significantly reduce damage to the engine or components, which may otherwise be caused by their activation at cold temperatures.

Still referring to FIG. 1, the heat source 18 can be remotely activated and operable by way of a remote controller 22 such as Bluetooth™ or similar applications, cellular telephones, satellite, or computer software, the controller being connected to a thermostat 24 located in the heat source 18. The user can simply program the remote controller 22 to activate the heat source 18 to respond to a lowering of temperature on the surface 12, as detected by the thermostat 24, by selecting a predetermined heating temperature and a predetermined heating time, both of which would be sufficient to melt the snow and/or ice. Advantageously, the heat source 18 can be activated to coincide with a weather forecast, which is predicting snowfall. Additionally, the heat source 18 might also include depth sensors (not shown), which measure the depth of snow and/or ice accumulation on the surface 14. Data from the depth sensors would then be transmitted to the remote controller 22, which would either increase the time of heating or would increase the temperature of the heat source 18.

Generally speaking, the heat source 18 can be selected from—but not limited to—a heating mat 26, warm air blower, heating stripes, heating lamps, microwaves, lasers, and ultrasound. It is to be understood that the heat source 18 is of sufficient size and deformability to allow maximum contact with the surface 12 to be heated by way of efficient thermal energy transfer.

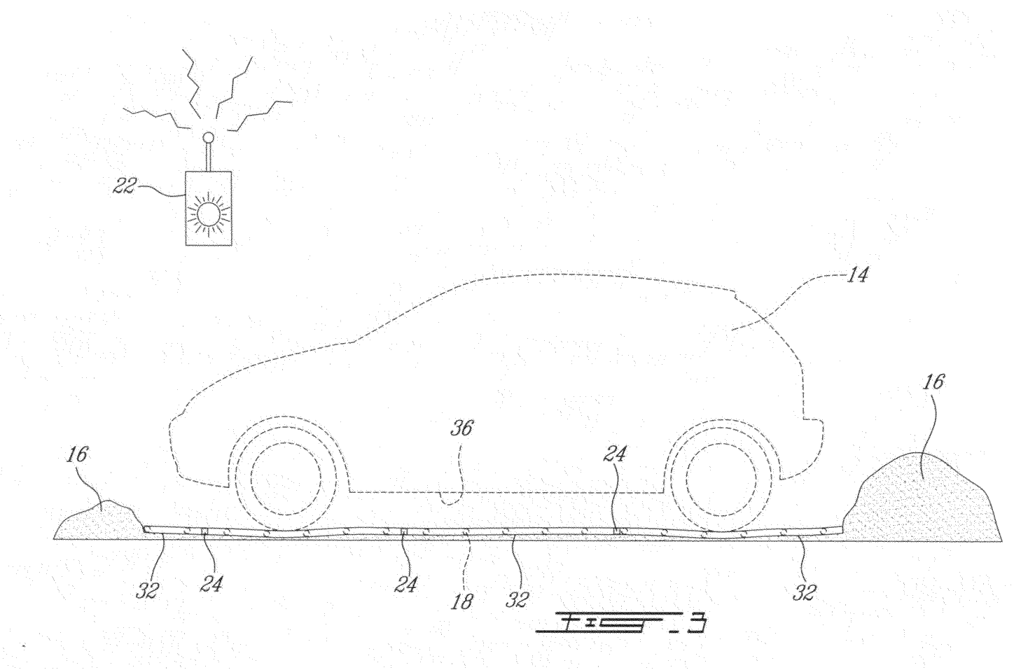

As best illustrated in FIG. 2, the heat source 18 may be a conduit 26 or a plurality of discrete conduits 28 or a plurality of chambers (not shown) which include an amount of a heat conductive material, such as warm water, oil, chemical elements, powders or compounds, gels, plasma-state materials, and any materials derived from nano or non-nanotechnologies in solid, gas, liquid or any other state, which, when activated, provides heat transfer to the surface 12. In the example shown, the heating apparatus is a heating mat 30 that may be sized and shaped to cover the cold surfaces of the vehicle, which can be used to reduce the snow and/or ice accumulated thereon or to prevent snow and/or ice from accumulating thereon. The mat 30 can be formed into the shape of the vehicle or it can be formed to cover at least a portion of the vehicle's surface 16, such as the lights, the wind shield and the like. The mat 30 may also be used to cover the engine or engine components. The heating mat 24 includes the heat source 18, which in the example illustrated is the conduit 26, and which is generally integrated into the mat 30 so as to not only provide maximum thermal energy transfer to the surface 12, but also to transfer heat to the mat 30 so that snow and/or ice in contact with the mat 30 will melt.

The heat source can be a warm air blower which blows warm air directly onto the surface 12, heating stripes, which provide heat to the areas adjacent the stripes, mini heating lamps, microwaves, lasers, ultrasound, oil, chemical elements, powders or compounds, gels, plasma-state materials, or any materials derived from nano or non-nanotechnologies in solid, gas, liquid or any other state, all of which may be located in the mat 30. Ultrasound is used to remove any material accumulated on the cold surface surface, including ice, water, dust or snow. Furthermore, the heat source may be a conduit, which includes an amount of a heat conductive material which when activated provides heat transfer to the surface. As described above, the heat source located in the mat 30 can be remotely activated by way of the remote controller 22 and the thermostats 24 located in the mat 24.

As mentioned above, one particularly troublesome aspect of snow and/or ice accumulation is when it occurs on a surface 32 near or underneath the vehicle, such as the driveway or road on which the vehicle is parked. As illustrated in FIG. 3, the heat source 18 may therefore be located adjacent the surface 32 such that, when activated, the heat source 18 heats the accumulated snow and/or ice, thereby allowing easy access to the vehicle 14 by the user and also to allow the user to drive the vehicle 14 away from the parking place. Moreover, the location of the heating source 18 directly underneath the vehicle 14 allows the thermal energy to be transferred to an underside 36 of the vehicle 14 so as to warm the exhaust system, the fuel lines and such. The thermostats 24 detect the temperature of the surface 32 and transmit the temperature information to the remote controller 22, which activates the heat source 18. The remote controller 22 system includes, but is not limited to, Bluetooth™ or similar applications, cellular telephones, satellite, or computer software.

Generally speaking, the heat source 18 may be powered by way of a battery, a power line, or via the vehicle's own climate control apparatus such as the interior heating apparatus or the vehicle's battery.

### Other Embodiments

From the foregoing description, it will be apparent to one of ordinary skill in the art that variations and modifications may be made to the invention described herein to adapt it to various usages and conditions. Such embodiments are also within the scope of the present invention.

I claim:

1. A heating apparatus for heating a cold surface of a vehicle or near the vehicle, the apparatus comprising: a heat source, the heat source being associated with the surface for providing thermal energy transfer from the heat source to the cold surface so as to heat the cold surface.

2. The apparatus, according to claim 1, in which the heat source is located adjacent the surface.

3. The apparatus, according to claim 1, in which the heat source is integral with the surface.

4. The apparatus, according to claim 1, in which the heat source is remotely activated.

5. The apparatus, according to claim 1, in which the heat source is powered by a battery or the vehicle's climate control apparatus.

6. The apparatus, according to claim 1, in which the heat source is selected from the group consisting of: a heating mat, warm air blower, heating stripes, heating lamps, microwaves, lasers, and ultrasound.

7. The apparatus, according to claim 1, in which the heat source is a conduit having disposed therein an amount of a heat conductive material which, when activated, provides heat transfer to the surface.

8. The apparatus, according to claim 1, in which the surface is the exterior skin of the vehicle.

9. The apparatus, according to claim 1, in which the surface is the engine or engine components.

10. The apparatus, according to claim 1, in which the surface is the underside of the vehicle.

11. The apparatus, according to claim 1, in which the surface is a driveway or road on which the vehicle is located.

12. The apparatus, according to claim 1, in which the heat source is thermostatically controlled.

13. The apparatus, according to claim 4, in which the remote activation is operable by way of Bluetooth™, cellular telephones, satellite, or computer software.

14. The apparatus, according to claim 1, in which the heat source transfers thermal energy to the surface sufficient to melt snow and ice accumulated thereon or to reduce the accumulation of snow and ice thereon.

15. A heating apparatus for heating a cold surface of a vehicle, the apparatus comprising: a heating mat for location adjacent the surface, the heating mat being sized and shaped to cover at least a portion of the surface for providing thermal energy transfer from the heating to the cold surface so as to heat the cold surface.

16. The apparatus, according to claim 15, in which the heating mat includes a heat source, the heat source being remotely activatable.

17. The apparatus, according to claim 16, in which the heat source is selected from the group consisting of: warm air blower, heating stripes, heating lamps, microwaves, lasers, and ultrasound.

18. The apparatus, according to claim 16, in which the heat source is a conduit having disposed therein an amount of a heat conductive material which when activated provides heat transfer to the surface.

19. The apparatus, according to claim 15, in which the surface is the exterior skin of the vehicle.

20. The apparatus, according to claim 15, in which the surface is the engine or engine components.

21. The apparatus, according to claim 16, in which the heat source transfers thermal energy to the surface sufficient to melt snow and ice accumulated thereon or to reduce the accumulation of snow and ice thereon.
